(19) United States
(12) Patent Application Publication
(10) Pub. No.: US 2026/0044730 A1
(43) Pub. Date: Feb. 12, 2026

(54) SYSTEMS AND METHODS FOR INTELLIGENT GENERATION OF TIME ENTRIES

(71) Applicants: Ahmed Farouk SHAABAN, South Barrington, IL (US); Venkat THANDRA, South Barrington, IL (US)

(72) Inventors: Ahmed Farouk SHAABAN, South Barrington, IL (US); Venkat THANDRA, South Barrington, IL (US)

(21) Appl. No.: 19/294,198

(22) Filed: Aug. 7, 2025

Related U.S. Application Data
(60) Provisional application No. 63/681,741, filed on Aug. 9, 2024.

(51) Int. Cl. G06N 3/08; G06Q 10/109

(52) U.S. Cl. CPC G06N 3/08; G06Q 10/109

(57) ABSTRACT

Systems and methods for generating intelligent time entries are disclosed herein. In an embodiment, a computer-implemented method of training a neural network to create time entries includes retrieving user data related to a task performed by a user, creating a first training set comprising the user data as an input and an approved time entry as an output, training the neural network in a first stage using the first training set, creating a second training set comprising the user data as an input and a revised time entry as an output, and training the neural network in a second stage using the second training set.

### RELATED APPLICATION

This application claims priority to U.S. Provisional Application No. 63/681,741, filed Aug. 9, 2024 and entitled “Systems and Methods for Intelligent Generation of Time Entries,” the entire contents of which is incorporated herein by reference and relied upon.

### BACKGROUND

### Technical Field

The present disclosure generally relates to systems and methods for intelligent creation of time entries. The present disclosure further relates to systems and methods for training a neural network to create time entries.

### Background Information

In many industries, accurate timekeeping is essential for project management and billing. Traditional methods of timekeeping require manual entry and are prone to errors, inefficiencies, lack of real time data and use of excess processing resources and memory space.

### SUMMARY

The present disclosure provides systems and methods for intelligent creation of time entries. The disclosed systems and methods are particularly advantageous in efficiently creating accurate time entries while reducing memory storage requirements at key points in the process. The disclosed systems and methods are also particularly advantageous because they seamlessly integrate with a variety of commonly used different types of productivity and collaborative software third party software such as Microsoft 365™ services, as well as with time management software such as the Epoch™ created by Fulcrum GT™.

A first aspect of the present disclosure is to provide a computer-implemented method of training a neural network to create time entries. The method includes retrieving user data related to a task performed by a user, creating a first training set comprising the user data as an input and an approved time entry as an output, training the neural network in a first stage using the first training set, creating a second training set comprising the user data as an input and a revised time entry as an output, and training the neural network in a second stage using the second training set.

A second aspect of the present disclosure is to provide a computer-implemented method of training a neural network to create time entries. The method includes generating a proposed time entry using the neural network with user data as an input, receiving an adjustment to the proposed time entry from a user, generating a revised time entry based on the adjustment to the proposed time entry by the user, creating a positive training set comprising the user data as a training input and data from the revised time entry as a training output, training the neural network in one stage using the positive training set, creating a negative training set comprising the user data as the training input and data from the proposed time entry as the training output, and training the neural network in another stage using the negative training set.

A third aspect of the present disclosure is to provide a method of generating time entries. The method includes recording, by a user at a user terminal, an amount of time elapsed between a start time and an end time on a particular date, retrieving user data related to the user which falls between the start time and the end time on the particular date, automatically generating an initial time entry having the elapsed time as a duration and a narrative generated by a neural network, presenting, via the user terminal, the generated time entry to the user who recorded the amount of time elapsed, and retraining the neural network based on the user approving or disapproving the generated time entry.

A fourth aspect of the present disclosure is to provide a system for generating time entries. The system includes a smart watch and a central server. The smart watch is configured to enable a user to record an amount of time elapsed between a start time and an end time on a particular date. The central server includes a controller having a processor and a memory. The memory stores a neural network configured to generate the time entries. The controller causes the processor to execute instructions stored on the memory to (i) retrieve user data related to a task performed by the user between the start time and the end time on the particular date, (ii) retrain the neural network using the user data as an input and one or more approved time entry as an output, and (iii) generate new time entries using the retrained neural network.

A fifth aspect of the present disclosure is to provide a system for generating time entries. The system includes a user terminal and a central server. The user terminal is configured to enable a user to record an amount of time elapsed between a start time and an end time on a particular date. The central server includes a controller having a processor and a memory. The memory stores a neural network configured to generate the time entries. The controller causes the processor to execute instructions stored on the memory to (i) retrieve user data related to a task performed by the user between the start time and the end time on the particular date, (ii) retrain the neural network using the user data as an input and one or more approved time entry as an output, and (iii) generate new time entries using the retrained neural network.

Other objects, features, aspects and advantages of the systems and methods disclosed herein will become apparent to those skilled in the art from the following detailed description, which, taken in conjunction with the annexed drawings, discloses exemplary embodiments of the disclosed systems and methods.

### BRIEF DESCRIPTION OF THE DRAWINGS

Referring now to the attached drawings which form a part of this original disclosure:

FIG. 1 illustrates an example embodiment of a system for intelligent creation of time entries in accordance with the present disclosure;

FIG. 2 illustrates an example embodiment of a system for intelligent creation of time entries in accordance with the present disclosure;

FIG. 3 illustrates an example embodiment of a user terminal which can be used in the system of FIGS. 1 and 2;

FIG. 4 illustrates an example embodiment of a method of creating intelligent time entries in accordance with the present disclosure using the system of FIGS. 1 and 2;

FIG. 5 illustrates an example embodiment of a graphical user interface generated on a user terminal during the method of FIG. 4;

FIG. 6 illustrates another example embodiment of a graphical user interface generated on a user terminal during the method of FIG. 4; and

FIG. 7 illustrates another example embodiment of a graphical user interface generated on a user terminal during the method of FIG. 4.

FIG. 8 illustrates another example embodiment of a graphical user interface generated on a user terminal during the method of FIG. 4.

FIG. 9 illustrates another example embodiment of a graphical user interface generated on a user terminal during the method of FIG. 4.

FIG. 10 illustrates another example embodiment of a graphical user interface generated on a user terminal during the method of FIG. 4.

FIG. 11 illustrates another example embodiment of a graphical user interface generated on a user terminal during the method of FIG. 4.

FIG. 12 illustrates another example embodiment of a graphical user interface generated on a user terminal during the method of FIG. 4.

FIG. 13 illustrates another example embodiment of a graphical user interface generated on a user terminal during the method of FIG. 4.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

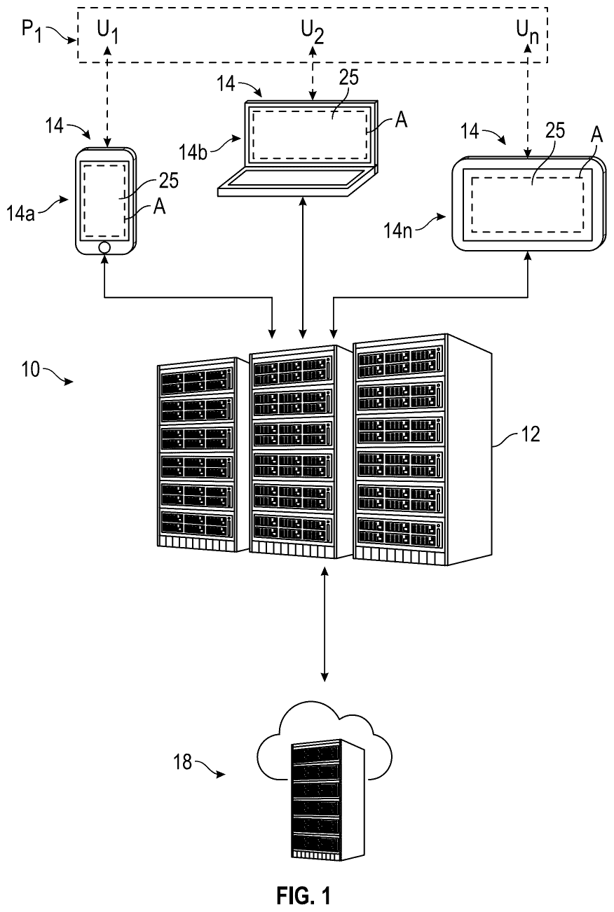

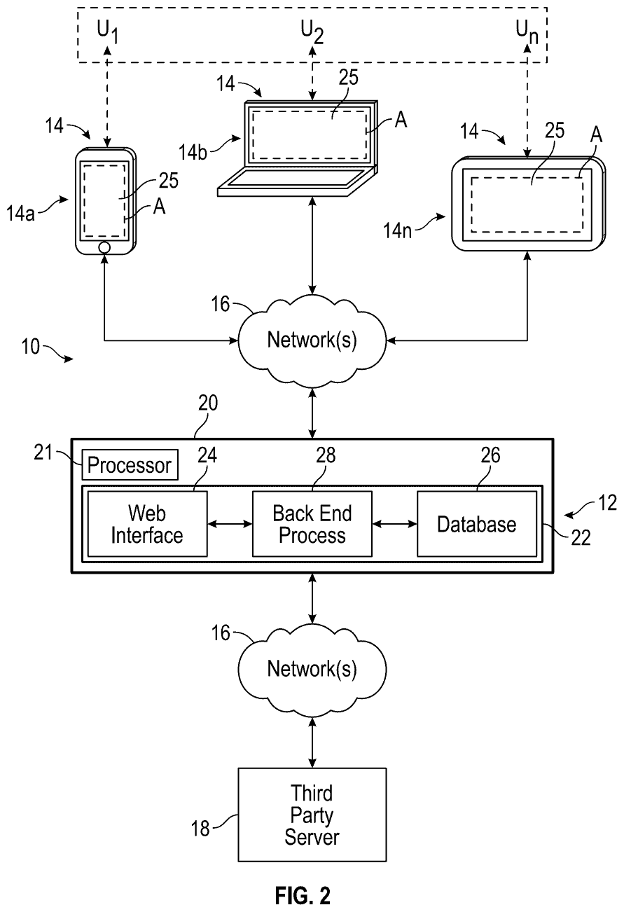

FIGS. 1 and 2 illustrate an example embodiment of a system 10 for intelligent creation of time entries. In the illustrated embodiment, the system 10 includes a central server 12 and one or more user terminals 14 operated by one or more users U₁, U₂ . . . Uₙ. The central server 12 is configured to wirelessly communicate with each of the user terminals 14 via a network 16 to perform various functions based on input from the user terminals 14 and/or one or more third party servers 18.

Each of the plurality of user terminals 14 can be, for example, a cellular phone, a tablet, a personal computer, a smart watch, or another personal electronic device. Here, the plurality of user terminals 14 includes a first user terminal 14a, a second user terminal 14b, and an nth user terminal 14n. Each user terminal 14 can be controlled by a distinct user U₁, U₂ . . . Uₙ (e.g., a first user U₁ controls the first user terminal 14a, a second user U₂ controls the second user terminal 14b, and an nth user Uₙ controls the nth user terminal 14n). As used herein, each of the users U₁, U₂ . . . Uₙ can also be referred to generally as a user U. Any user U can log into the system 10 and provide input regarding one or more generated time entries using a user terminal 14.

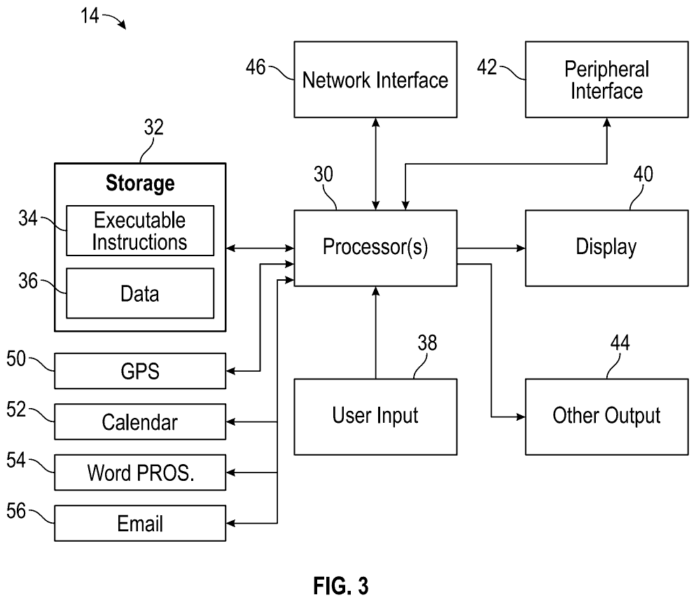

FIG. 3 illustrates a representative diagram of an example embodiment of a user terminal 14. As illustrated, a user terminal 14 can include a terminal processor 30 and a terminal memory 32. The terminal processor 30 is configured to execute instructions programmed into and/or stored by the terminal memory 32. The instructions can be received from and/or periodically updated by the web interface 24 of the central server 12 in accordance with the methods discussed herein. As described in more detail below, certain of the functions described herein can be stored as instructions in the terminal memory 32 and executed by the terminal processor 30.

In an embodiment, the terminal processor 30 can comprise one or more of a microprocessor, microcontroller, digital signal processor, co-processor or the like or combinations thereof capable of executing stored instructions 34 and operating upon stored data 36, wherein the instructions 34 and/or stored data 36 are stored by the terminal memory 32. The terminal memory 32 can comprise one or more devices such as volatile or nonvolatile memory, for example, random access memory (RAM) or read only memory (ROM). Further, the terminal memory 32 can be embodied in a variety of forms, such as a hard drive, optical disc drive, floppy disc drive, etc. In an embodiment, many of the processing techniques described herein are implemented as a combination of executable instructions 34 and data 36 stored within the terminal memory 32.

As illustrated, each of the plurality of user terminals 14 includes one or more user input device 38, a display 40, a peripheral interface 42, one or more other output device 44, and a network interface 46 in communication with the terminal processor 30. The user input device 38 can include any mechanism for providing a user input to the terminal processor 30, for example, a keyboard, a mouse, a touch screen, a microphone and/or suitable voice recognition application, or another input mechanism. The display 40 can include any conventional display mechanism such as a cathode ray tube (CRT), a flat panel display, a touch screen, or another display mechanism. Thus, as can be understood, the user input device 38 and/or the display 40 and/or any other suitable element can be considered a GUI 25. The peripheral interface 42 can include the hardware, firmware, and/or other software necessary for communication with various peripheral devices, such as media drives (e.g., magnetic disk or optical disk drives), other processing devices, or another input source used as described herein. Likewise, the other output device 44 can optionally include similar media drive mechanisms, other processing devices or other output destinations capable of providing information to a user of the user terminal 14, such as speakers, LEDs, tactile outputs, etc. The network interface 46 can comprise hardware, firmware and/or software that allows the terminal processor 30 to communicate with other devices via wired or wireless networks 16, whether local or wide area, private or public. For example, such networks 16 can include the World Wide Web or Internet, or private enterprise networks, or the like.

In various embodiments discussed herein, the user terminal 14 can include one or more user data application configured to track and/or periodically gather user data 36 regarding the user U of the user terminal 14. Such a user data application(s) can include, for example, a global positioning system (“GPS”) application 50, a digital calendar application 52, a word processing application 54, an email application 56, and/or another terminal-specific application which tracks movements and/or data usage by the user U of the user terminal 14. In an embodiment, the GPS application 50, the digital calendar application 52, the word processing application 54 and/or the email application 56 can be integrally included with the user terminal 14. Alternatively, the user terminal 14 can be placed in wireless communication with the GPS application 50, the digital calendar application 52, the word processing application 54 and/or the email application 56 so as to enable operation as described herein. In an embodiment, the user data gathered from a user data application such as a GPS application 50, a digital calendar application 52, a word processing application 54, an email application 56 and/or another terminal-specific device can be stored as data 36 within the terminal memory 32 and accessed by the central server 12 as needed.

The GPS application 50 can be used, for example, to record past or present data regarding the physical location of the user terminal 14, which can be used to determine the physical locations of the user U who typically uses the user terminal 14. In an embodiment, an application A downloaded to the user terminal 14 is configured to automatically access the user U's past or present locations without the user U having to separately navigate and open up the GPS application 50 to retrieve the data. In an embodiment, the user U of a user terminal 14 can be required to enable access to the GPS application 50 for the system 10 to determine and/or utilize the user U's past or present locations. In an embodiment, relevant data from the GPS application 50 can be stored as data 36 within the terminal memory 32 and accessed by the central server 12 as needed.

The digital calendar application 52 can be, for example, a calendar application which is downloaded to the user terminal 14 and/or stores the user U's past, present, and/or future commitments. In an embodiment, the digital calendar application 52 can be associated with the user U's email. The digital calendar application 52 can be stored on the terminal memory 32, or can be stored on an alternative memory device and accessed by the user terminal 14 via wireless communication over the network 16. In an embodiment, relevant data from the digital calendar application 52 can be stored as data 36 within the terminal memory 32 and accessed by the central server 12 as needed. In an embodiment, an application A downloaded to the user terminal 14 is configured to automatically access the user U's digital calendar application 52 without the user U having to separately navigate and open up the digital calendar application 52 to retrieve the calendar data. The digital calendar application 52 can store data related to the user on using cloud storage of a third party server 18, which the central server 12 can then access from the cloud storage as opposed to the user terminal 14.

The word processing application 54 can be used, for example, to create, edit and/or store documents created or edited by the user U using the user terminal 14. In an embodiment, the word processing application 54 can include Microsoft Word or another similar word processing program that enables a user U to create, edit and/or store digital documents. The word processing application 54 can be stored on the terminal memory 32, or can be stored on an alternative memory device and accessed by the user terminal 14 via wireless communication over the network 16. In an embodiment, relevant data from the word processing application 54 can be stored as data 36 within the terminal memory 32 and accessed by the central server 12 as needed. In an embodiment, an application A downloaded to the user terminal 14 is configured to automatically access the word processing application 54 without the user U having to separately navigate and open up the word processing application 54 to retrieve the document data. The word processing application 54 can store data related to the user on using cloud storage of a third party server 18, which the central server 12 can then access from the cloud storage as opposed to the user terminal 14.

The email application 56 can be used, for example, to create, edit, send, receive and/or store emails to or from the user U using the user terminal 14. In an embodiment, the email application 56 can include Microsoft Outlook or another similar email application that enables a user U to create, edit, send, receive and/or store emails. The email application 56 can be stored on the terminal memory 32, or can be stored on an alternative memory device and accessed by the user terminal 14 via wireless communication over the network 16. In an embodiment, relevant data from the email application 56 can be stored as data 36 within the terminal memory 32 and accessed by the central server 12 as needed. In an embodiment, an application A downloaded to the user terminal 14 is configured to automatically access the email application 56 without the user U having to separately navigate and open up the email application 56 to retrieve the email data. The email application 56 can store data related to the user on using cloud storage of a third party server 18, which the central server 12 can then access from the cloud storage as opposed to the user terminal 14.

While the user terminal 14 has been described as one form for implementing the techniques described herein, those having ordinary skill in the art will appreciate from this disclosure that other functionally equivalent techniques can be employed. For example, some or all of the functionality implemented via executable instructions can also be implemented using firmware and/or hardware devices such as application specific integrated circuits (ASICs), programmable logic arrays, state machines, etc. Further, user data can include operating system data. Further, other implementations of the user terminal 14 can include a greater or lesser numbers of components than those illustrated. Further still, although a single user terminal 14 is illustrated in FIG. 3, it should be understood from this disclosure that a combination of such devices can be configured to operate in conjunction (for example, using known networking techniques) to implement the methods described herein.

Referring again to FIG. 1, the central server 12 can comprise one or more server computers, database servers and/or other types of computing devices, particularly in connection with, for example, the implementation of websites and/or enterprise software. The central server 12 includes a central controller 20. The central controller 20 includes a central processor 21 and a central memory 22. The central processor 21 is configured to execute instructions programmed into and/or stored by the central memory 22. In an embodiment, the central processor 21 can comprise one or more of a microprocessor, microcontroller, digital signal processor, co-processor or the like or combinations thereof capable of executing stored instructions and operating upon stored data, wherein the instructions and/or data are stored by the central memory 22. The central memory 22 can comprise one or more devices such as volatile or nonvolatile memory, for example, random access memory (RAM) or read only memory (ROM). Further, the central memory 22 can be embodied in a variety of forms, such as a hard drive, optical disc drive, floppy disc drive, etc. As described in more detail below, the steps of the methods described herein can be stored as instructions in the central memory 22 and executed by the central processor 21.

In the illustrated embodiment, the central memory 22 can include a web interface 24, a database 26, and back end processing instructions 28. Here, the web interface 24, the database 26, and the back end processing instructions 28 can be controlled or accessed by the central controller 20 implementing appropriate software programs by executing the back end processing instructions 28 or other instructions programmed into and/or stored by the central memory 22.

The web interface 24 can provide a graphical user interface (“GUI”) 25 that can be displayed on a terminal 14 for a user U, and can manage the transfer of data received from and sent to the GUI 25 on the terminal 14. In an embodiment, each user terminal 14 can include an application A comprising software downloaded to and executed by the user terminal 14 to provide the GUI 25 and to manage communications with the central server 12. The application A can be downloaded to the user terminal 14 from the central server 12 or from some other source such as an application distribution platform. The application A is configured to access the user terminal 14's GPS application 50, digital calendar application 52, word processing application 54 and/or email application 56 without the user U having to separately open up and navigate separate applications to retrieve the data needed for the central server 12 to execute the methods discussed herein.

The database 26 can store time entries, as well as data retrieved from the user terminal 14 and/or data created by the central server 12 to generate time entries. In an embodiment, the database 26 can comprise a database management system (DBMS) operating on one or more suitable database server computers. In an embodiment, the database 26 can include a plurality of sub-databases. Storage and use of the database 26 is discussed in more detail below.

The back end processing instructions 28 can be operatively coupled to both the web interface 24 and the database 26, and can be programmed into and/or stored by the central memory 22 and implemented by the central processor 21. In an embodiment, the back end processing instructions 28 can be executed by the central processor 21 to direct operations of the central server 12 as described below in further detail. For example, the central processor 21, executing the back end processing instructions 28, can manage the receipt, storage, maintenance, etc. of relevant data. Additionally, the central processor 21, executing the back end processing instructions 28, can develop the database 26 and/or a neural network used to implement the system 10, as discussed in more detail below.

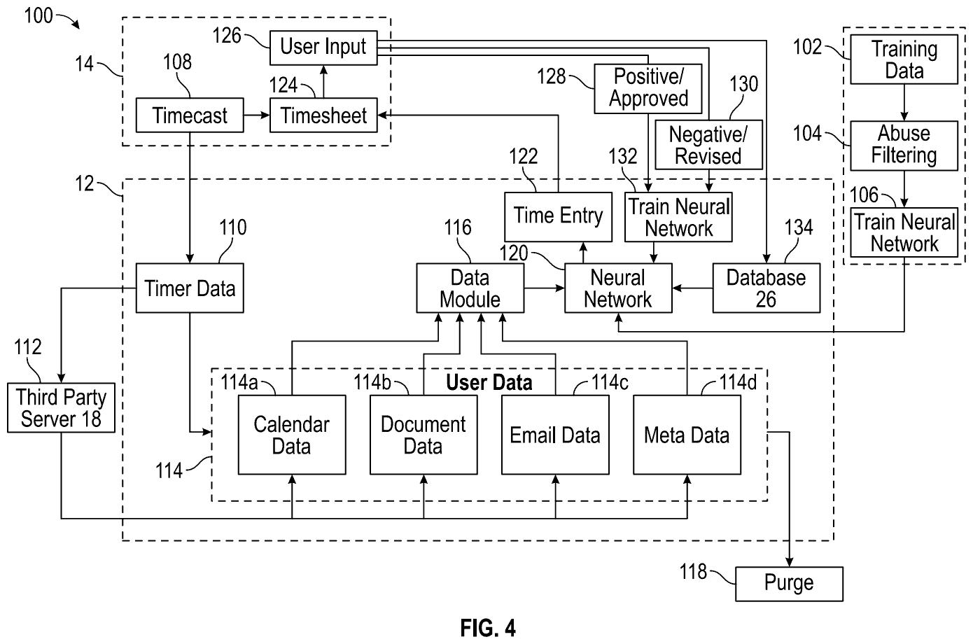

FIG. 4 illustrates an example embodiment of a method 100 of creating intelligent time entries in accordance with the present disclosure. The method 100 can be implemented by the system 10 described herein. In an embodiment, one or more of the steps of the method 100 can be executed by the central controller 20 using instructions stored on the central memory 22 and executed by the central processor 21. In an embodiment, one or more of the steps of the method 100 can be stored as instructions on the terminal memory 32 and executed by the terminal processor 30. It should be understood by those of ordinary skill in the art from this disclosure that some of the steps described herein can be reordered or omitted without departing from the spirit or scope of method 100.

At steps 102, 104 and 106, the central controller 20 trains an initial neural network for use by the central server 12 during the method 100. In an embodiment, the method 100 is performed for a specific entity (e.g., an accounting firm, consulting firm, law firm, or another entity that uses time entries in the regular course of business). The method 100 can be performed separately for each of a plurality of multiple entities. This way, each trained neural network is personalized for the specific entity and the data generated by the neural network will reflect that specific entity's preferred form of time entries. In a further embodiment, the method 100 is separately performed for each of a plurality of different clients of the specific entity, such that the data generated by the neural network will reflect that specific client's preferred form of time entries for reporting. Thus, a single entity may perform a first method 100 and isolate the data generated for a first client, and may perform a second method 100 and isolate the data generated for a second client. In that case, the first method and the second method 100 will be isolated from each other and the neural network training sets will generally not overlap.

At step 102, a set of initial training data is created from a plurality of time entries. The set of initial training data can include a first data set of time entries that include narratives that are approved for one or more clients and a second data set of time entries that are not approved for one or more clients. The initial training data can be specific to the entity or client which the time entries generated by the method 100 are used for.

At step 104, the initial training data undergoes abuse filtering. For example, the abuse filtering can be used to make sure narratives do not have abusive or inappropriate language or language that one or more clients do not approve for billed time entries. The abuse filtering can be used to make time durations for time entries do not exceed a certain limit.

At step 106, a neural network is initially trained. In an embodiment, the neural network is a large language model (LLM) neural network. One advantage of the method 100 disclosed herein is that if at any point the neural network becomes unusable or is not creating accurate time entries at step 122, the neural network can be reset by restarting the method 100 and rerunning steps 102, 104 and 106 for a specific entity or client.

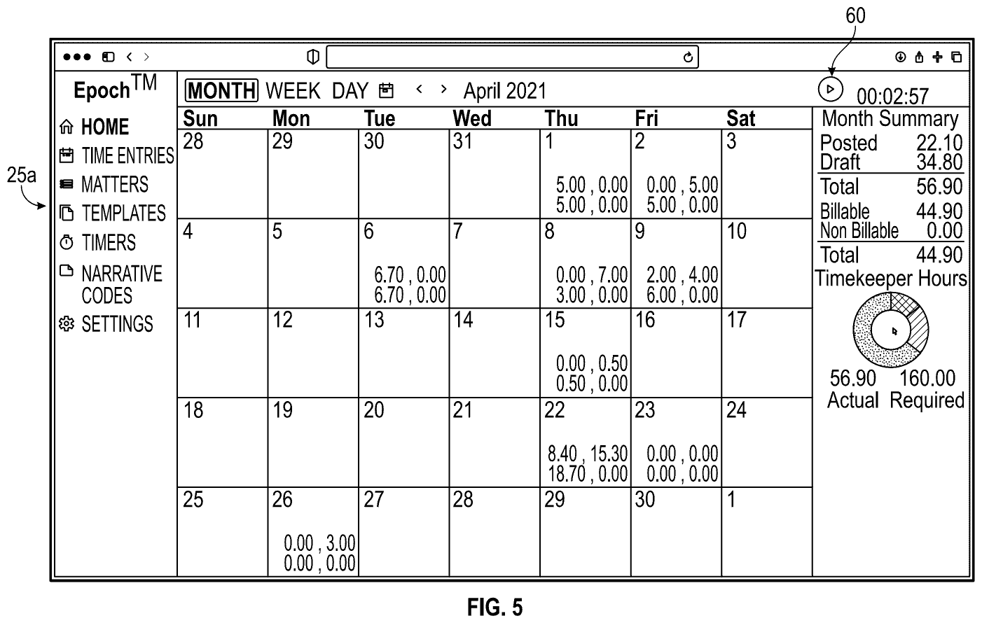

In an embodiment, at step 108, a user U uses a user terminal 14 to record an amount of time. FIG. 5 illustrates an example embodiment of a GUI 25a displayed on a user terminal 14 which allows a user U to record an amount of time. In the illustrated embodiment, the GUI 25a is a home screen for a desktop computer, laptop computer, smart phone or tablet. In the illustrated embodiment, the home screen of the GUI 25a is configured to display a summary of time entry data for the respective user U of the user terminal 14. In the illustrated embodiment, the GUI 25a is in a calendar format to allow a user U to select (e.g., click on) any day to enter time entry data for that day.

In the illustrated embodiment, the GUI 25a includes a running timer 60. The running timer 60 can be started and/or stopped by the user U by selecting (e.g., clicking on) the illustrated icon. When a user U starts and then stops the running timer 60, the user terminal 14 creates timer data for transmission to the central server 12. The timer data can include, for example, the current date, a beginning time when the user U started the running timer 60, an ending time that the user U stopped the running timer 60, and/or a total time that the running timer 60 ran for from start to stop. This data can further be combined with one or more GPS location recorded by the GPS application 50 between the beginning time and the end time recorded by the running timer 60.

In an embodiment, user terminal 14 is a smart watch worn by the user U, and the user U can start and stop the running timer 60 using the smart watch. This allows the user U to enable the running timer 60 when away from a computer or other electronic device which displays the GUI 25. Thus, in an embodiment, a user terminal 14 includes a smart watch with a running timer 60, and a user U can start or stop the running timer 60 as the user U goes about his or her day. Each time the user U stops the running timer, the user terminal 14 can export the timer data to the central server 12 of the system 10 for use in the method 100 as discussed herein. As with above, the timer data can include the date, the beginning time, the ending time and/or the total time. In an embodiment, the timer data can also include or indicate one or more location recorded by the GPS application 50 between the beginning time and the end time recorded by the running timer 60.

Referring again to FIG. 4, at step 110, the central server 12 receives the timer data from the user terminal 14. The central server 12 receives timer data including one or more of date, start time, stop time, total time and/or GPS location(s) recorded between the start time and the stop time. The central controller 50 temporarily stores the timer data and determines certain user data to be requested from the third party server 18 based on the parameters of the timer data. In an embodiment, the user terminal 14 uses the timer data to create user data for further processing including one or more of date, start time, stop time, total time and/or GPS location(s) recorded between the start time and the stop time.

In another embodiment, the method 100 skips steps 108 and 110 and begins with step 112. In this embodiment, the central controller 20 determines one or more of the date, start time, stop time and/or total time based on data retrieved from the third party server 18 and/or the digital calendar application 52, the word processing application 54 and/or the email application 56.

At step 112, the central controller 20 requests or retrieves user data from the third party server 18. In an embodiment, when the central controller 20 has timer data from the running timer 60, the central controller 20 requests or retrieves user data from the third party server 18 that was created, modified or otherwise used on the date of the timer data and between the start time and the end time. In another embodiment, the central controller 20 requests or retrieves user data from the third party server 18 that was created, modified or otherwise used on a given date and/or within a given time period. For example, the user U may use the user terminal 14 to request that the central server 12 generate time entries for a given date and/or within a given time period. Or the user U of the user terminal 14 may use the user terminal 14 to request that the central server 12 generate time entries for unknown time periods to be determined by the central controller 20 after analyzing user data that the central controller 20 requested or retrieved from the third party server 12. In an embodiment, particularly as the neural network is continuously trained through the method 100, the method 100 can account for each of these and other scenarios where specific dates and times are not needed to request or retrieve user data and generate corresponding time entries. Due to the continuous training of the neural network as described herein, the central controller 20 may require less data as the method 100 proceeds and the neural network is more accurately trained, which frees up processing resources and memory space for other tasks to be performed by the central server 12.

In an embodiment, the third party server 12 includes Microsoft Office 365 cloud data. The central controller 20 is configured to request or retrieve user data relating to the user's emails, electronic documents, electronic calendar entries and/or other sources, as well as metadata from these and other sources. At step 114, the central controller 20 receives and processes the user data from the third party server 18 to determine and weigh whether it relates to the time period of the timer data. As illustrated, in an embodiment, the central controller 20 is configured to receive and process different types of user data based on the parameters of the timer data.

In an embodiment, at step 114a, the central controller 20 receives and processes user data related to the user's digital calendar 52. For example, the central controller 20 can determines which events on the user's digital calendar 52 fall between the start time and the end time of the running timer 60 on a particular day. The central controller 20 then temporarily stores those events and/or data related to those events. In an embodiment, the central controller 20 can determine the dates and times of any entries in the user's digital calendar and use those dates and times in the generation of time entries. In an embodiment, the central controller 20 can also determine dates and times of open spaces in the user's digital calendar and use those dates and times in the generation of time entries. The determined data points and metadata are then transferred to the data module at step 116. The determined data points and metadata can include the determined dates and times as well as any titles, narratives or other persons involved in events on the user's digital calendar 52. The electronic controller 50 sends the remaining data that was not sent to the data module as step 116 to purge at step 118.

In an embodiment, at step 114b, the central controller 20 receives and processes user data related to the user's word processing application 54. For example, the central controller 20 determines which electronic documents were created, edited/modified and/or stored between the start time and the end time of the running timer 60 on a particular day. The central controller 20 then temporarily stores those documents and/or data related to those documents. In an embodiment, the central controller 20 can determine the dates and times that were created, edited/modified and/or stored and use those dates and times in the generation of time entries. The determined data points and metadata are then transferred to the data module at step 116. The determined data points and metadata can include the determined dates and times as well as any titles, written descriptions or other persons involved with electronic documents from the word processing application 54. The electronic controller 50 sends the remaining data that was not sent to the data module as step 116 to purge at step 118.

In an embodiment, at step 114c, the central controller 20 receives and processes user data related to the user's email application 56. For example, the central controller 20 determines which emails were created, sent and/or received between the start time and the end time of the running timer 60 on a particular day. The central controller 20 then temporarily stores those emails and/or data related to those emails. In an embodiment, the central controller 20 can determine the dates and times that emails were created, edited/modified and/or sent and use those dates and times in the generation of time entries. The determined data points and metadata are then transferred to the data module at step 116. The determined data points and metadata can include the determined dates and times as well as any subjects, written descriptions or other persons (e.g. to, from, cc'd or bcc'd) involved with the emails. The electronic controller 50 sends the remaining data that was not sent to the data module as step 116 to purge at step 118.

In an embodiment, at step 114d, the central controller 20 retrieves and processes other metadata related to one or more user applications. The metadata can be from other similar applications besides the digital calendar 50, the word processing application 54 and/or email application 56. The metadata can include, for example, data related to correspondence, meetings or documents such as last modified, sender, recipient, date, last modified by, word count, word count history, time period falling within a narrative, email time sent, delta between previous versions of a document, etc., recorded between the start time and the end time of the running timer 60 on a particular day and/or recorded between the start time and the end time determined from the data received by the central server 12 from the third party server 18. The central controller 20 then temporarily stores the metadata. The relevant metadata is then transferred to the data module at step 116. The electronic controller 50 sends the remaining data that was not sent to the data module as step 116 to purge at step 118.

At step 116, the central controller 20 stores the user data from step 114 within a data module. In an embodiment, the central controller 20 stores the user data that it has determined to fall between the start time and the end time on a particular day, for example, based on the time period determined from the running time 60, third party server 18 or otherwise in step 114. More specifically, the central controller 20 stores one or more of the calendar data, the document data, the email data and the metadata that falls between the start time and the end time of the running timer 60 on a particular day. The data module filters the data into chunks that can be used as the input for the neural network. For example, the data module can transform the user data into a matrix of data representative of the user data. For example, the data module may filter the data into chunks and then include matrix entries related to one or more of start time, end time, total time, date, any titles, narratives or other persons involved in events on the user's digital calendar 52, any titles, written descriptions or other persons involved with electronic documents from the word processing application 54, and any subjects, written descriptions or other persons (e.g. to, from, cc'd or bcc'd) involved with the user's emails, including one or more of last modified, sender, recipient, date, last modified by, word count, word count history, time period falling within a narrative, email time sent, delta between previous versions of a document, GPS location, etc. When the data module does not have relevant data for one of the plurality of categories of user data, the data module can use an empty or zero entry in the matrix. Thus, in an embodiment, the data module at step 116 can output a data matrix with entries in a plurality of categories as well as one or more empty or zeroed entries. The data module can use the same matrix structure (rows and/or columns) for different data sets processed using the method 100 as described herein, even though different data sets may be missing data for certain categories. By using the same matrix structure for different data sets processed using the method 100, the central controller can train the neural network to create time entries even with relevant data missing for certain categories. Using the same matrix structure can assist with data that may come from various devices such as mobile devices, personal data assistants, and other data sources.

At step 118, the central controller 20 purges its memory 22 of all data from step 114 that is not temporarily stored in the data module at step 116. By deleting all data that is not stored in the data module at this point in the method 100, the central controller 20 frees up additional memory space and reduces processing resources for the next set of user data. In an embodiment, the central memory 22 is purged when a user U approves or disapproves of a proposed time entry at step 126. In an embodiment, the central memory 22 is also purged when a timer runs out, whether or not the user has approved a proposed time entry at step 126 by then.

At step 120, the central controller 20 inputs the user data in the form created by the data module at step 116 into the neural network. More specifically, the central controller 20 inputs the user data stored in the data module into the neural network using the new data form created at step 116. For example, the central controller 20 uses the data matrix format created by the data module as the input to the neural network. In an embodiment, the data module continues to store the user data in the matrix format at this point while waiting for feedback from the user terminal 14. The data module is then purged of the user data, for example, after a user U approves a proposed time entry at step and 128, disapproves and/or edits a proposed time entry at step 130, or when a timer expires whether or not the user U has approved or disapproved of a proposed time entry by then. By deleting all data stored in the data module at this point in the method 100, the central controller 20 frees up additional memory space and reduces processing resources for the next set of user data to be processed in accordance with the method 100.

At step 122, the neural network outputs a proposed time entry using the user data in the data structure created by the data module as the input. The proposed time entry can include one or more of client, matter, task, location, duration and/or narrative. The central controller 20 generates one or more of the client, matter, task, location, and/or narrative using the neural network. In an embodiment, the duration is the amount of total time recorded by the running timer 60 at step 108. In another embodiment, the duration is an amount of time determined from documents, emails, calendar entries or other meta data at step 114. For example, the duration is an amount of time can be an amount of time that the digital calendar application 52, the word processing application 54 and/or the email application 56 is open and/or actively being used by the user U. In an embodiment, the location is the GPS location recorded by the GPS device 50 between the start time and the end time on the particular date. The central controller 20 then transmits the proposed time entry to the user terminal 14.

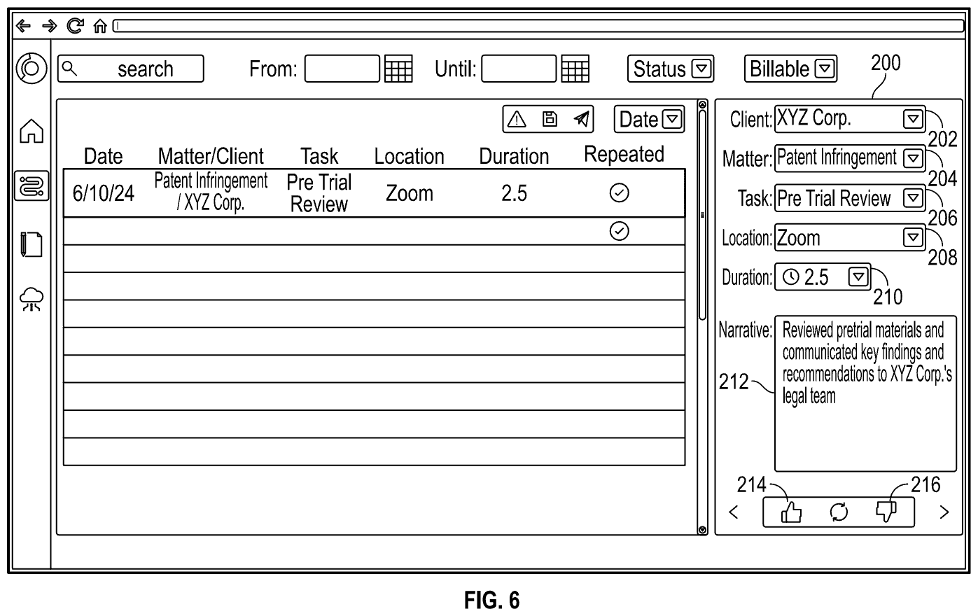

At step 124, the user terminal 12 presents the proposed time entry to the user U using the GUI 25. FIG. 6 illustrates an example embodiment of a GUI 25b presenting a proposed time entry 200 to a user U via the application A. As illustrated, the proposed time entry 200 includes a client entry 202, a matter entry 204, a task entry 206, a location entry 208, a duration entry 210 and/or a narrative entry 212. The GUI 25b also prevents the user U with a selection of either a positive icon 214 or a negative icon 216.

At step 126, the user U approves or disapproves of the time entry 200 by selecting the positive icon 214 or a negative icon 216. The user U selects the positive icon 214 when the user U approves of all categories in the proposed time entry 200 generated by the neural network. The user U selects the negative icon 216 when the user U does not approve of one or more of the categories in the proposed time entry 200 generated by the neural network. Based on the user U selection, the proposed time entry 200 is designated as a positive example data set at step 128 or as a negative example data set at step 130.

When the user U chooses the positive icon 214, the proposed time entry 200 is designated as a positive example at step 128. The neural network is then retrained at step 132 using the user data structure created at the data module at step 116 as the input, and with the proposed time entry 200 designated as a positive example at step 128 as the output. Additionally, upon selection of the positive icon 214, the proposed time entry 200 is sent to and stored in the database 26 at step 134, so that the time entry 200 can be added to an invoice and/or used as an additional training example in the future. The data module is then purged of the user data used to generate the proposed time entry.

When the user U chooses the negative icon 216, the proposed time entry 200 is designated as a negative example at step 130. The neural network is then trained at step 132 using the user data structure created at the data module at step 116 as the input, and with the proposed time entry 200 designated as a negative example at step 130 as the output.

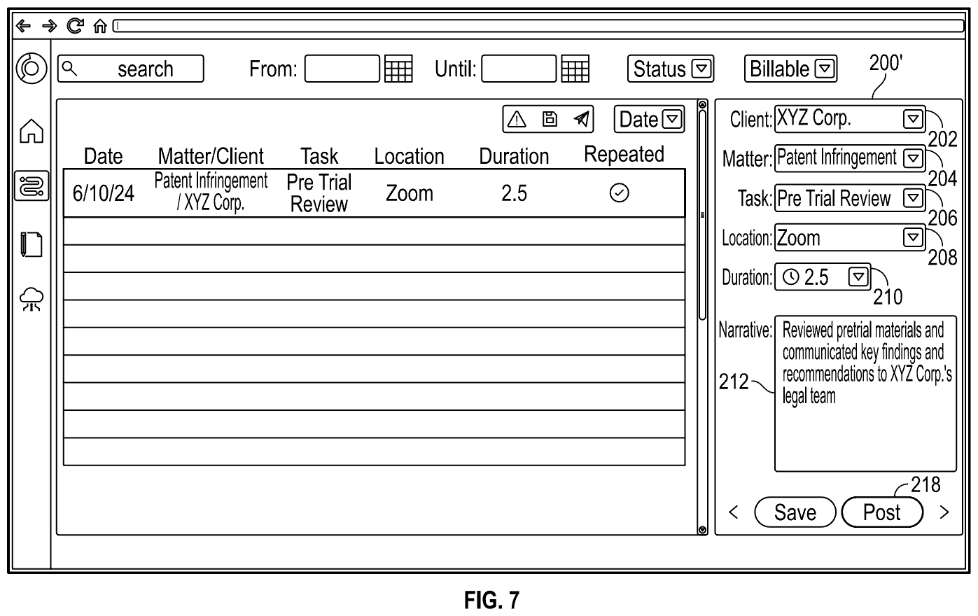

Additionally, upon selection of the negative icon 216, the user terminal 14 enables the user U to adjust one or more parameters of the proposed time entry 200 at step 126. FIG. 7 illustrates an example embodiment of a GUI 25c which enables the user U to create a revised time entry 200′ by adjusting one or more parameter of the client entry 202, the matter entry 204, the task entry 206, the location entry 208, the duration entry 210 and/or the narrative entry 212. The user U then uses the save or post icon 218 to cause the revised time entry 200′ to be sent to and stored in the database 26 at step 134, so that the revised time entry 200 can be added to an invoice and/or used as an additional training example in the future. The revised time entry 200′ is also used as an additional positive data set to further train the neural at step 132. More specifically, the neural network is then trained at step 132 using the user data structure created at the data module at step 116 as the input, and with the revised time entry 200′ designated as a positive example at step 128 as the output. Thus, when the user U makes a change to a proposed time card 200, the central controller 20 is configured to train the neural network with both a positive example data set and a negative example data set using the user data structure created at the data module at step 116 as the input for both the positive example data set and the negative example data set. By using consistent input and output data structure, the neural network is trained to more accurately create the desired output based on input in the consistent data structure. Further, by creating both positive and negative data sets based on a user U revision and using the same input data structure for each training session, the neural network is trained to make minor adjustments to future proposed time entries 200 that are consistent with the changes.

In an embodiment, the central controller 20 can train the neural network for each of a plurality of separate users U or groups of users U. For example, a plurality of users U can begin with the same neural network being created or initially trained at steps 102, 104 and 106. But as a particular user U approves or disapproves of generated proposed time entries 200 at step 126, the neural network is trained for that particular user U using the positive and negative data sets as discussed herein. Each user U will thus have an individually personalized neural network.

In an embodiment, at step 134, the central controller 20 can further train the neural network using batches of approved time entries saved in the database 26 as positive data sets. The central controller 20 can use step 134, for example, to train the neural network in different ways for different clients and/or to retrain the neural network if replaced or reset.

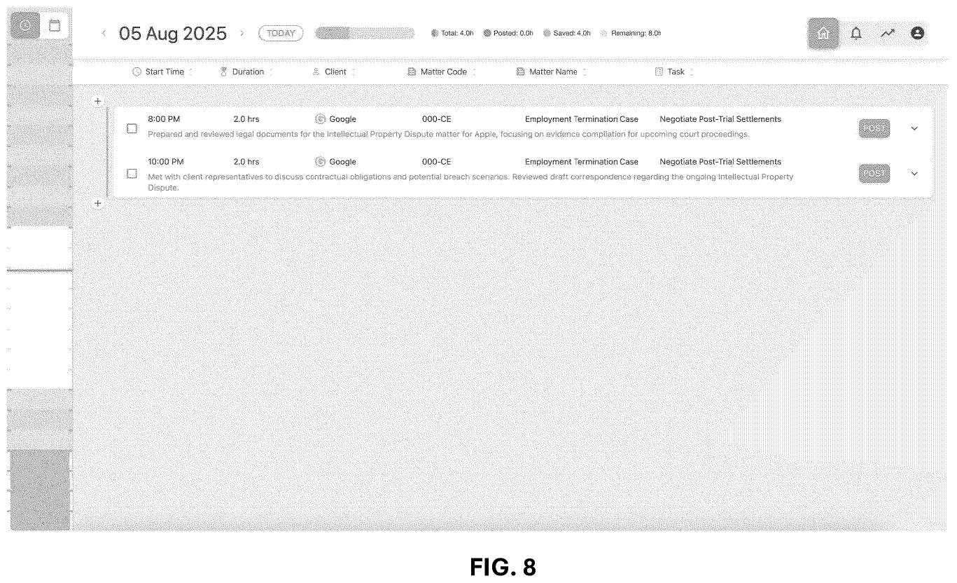

FIGS. 8 through 13 also illustrate example embodiments of a GUI 25c which enables the user U to review and edit the client entry 202, the matter entry 204, the task entry 206, the location entry 208, the duration entry 210 and/or the narrative entry 212.

FIG. 8 specifically illustrates a summary screen with sidebar showing a narrative entry 212 snippet.

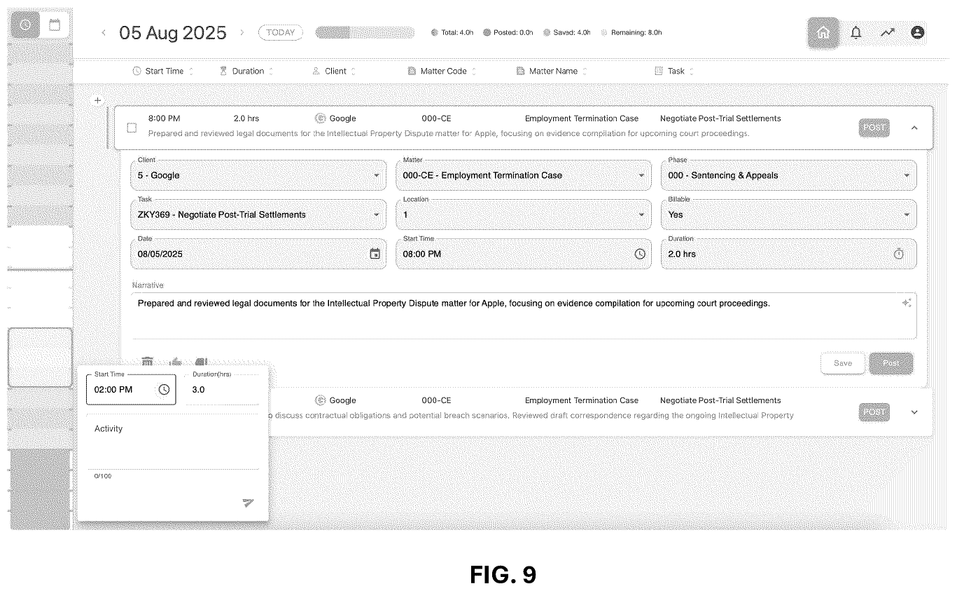

FIG. 9 specifically illustrates a summary screen with sidebar showing a narrative entry 212 in a detailed view.

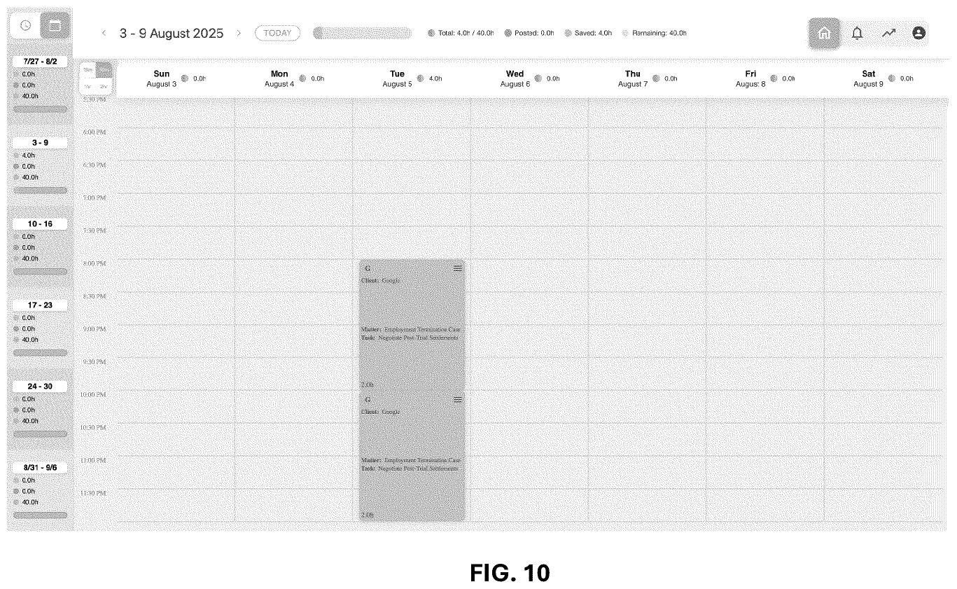

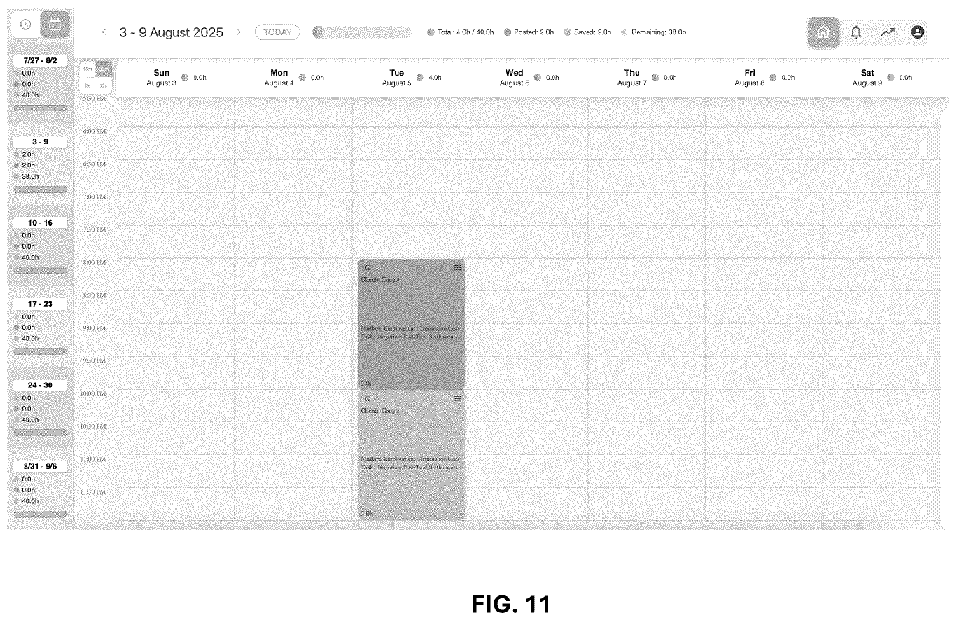

FIGS. 10 and 11 specifically illustrate a digital calendar 52 showing matrix entries reflecting data such as any titles, written descriptions or other persons involved with electronic documents from the word processing application 54, and any subjects, written descriptions or other persons (e.g. to, from, cc'd or bcc'd) involved with the user's emails, including one or more of last modified, sender, recipient, date, last modified by, word count, word count history, time period falling within a narrative, email time sent, delta between previous versions of a document, GPS location, etc.

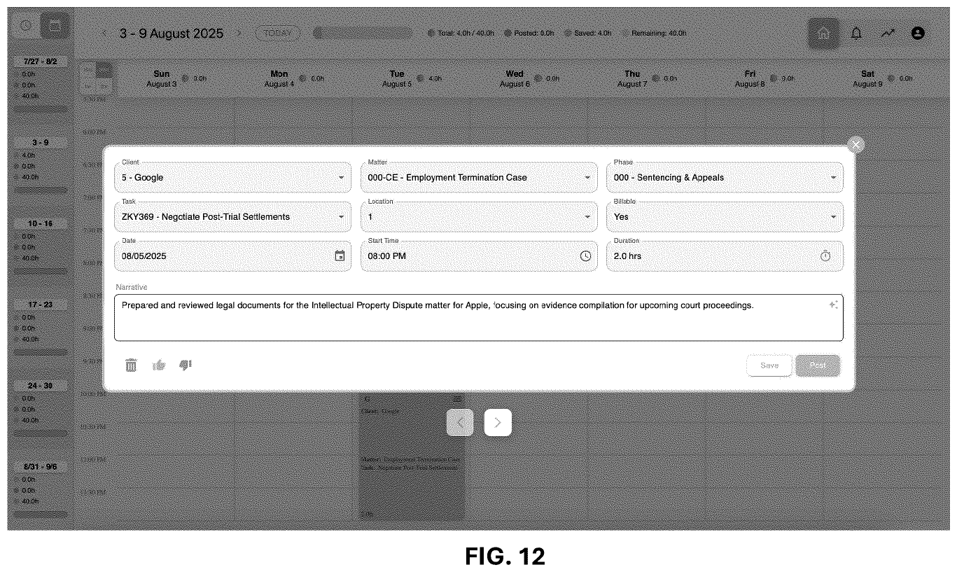

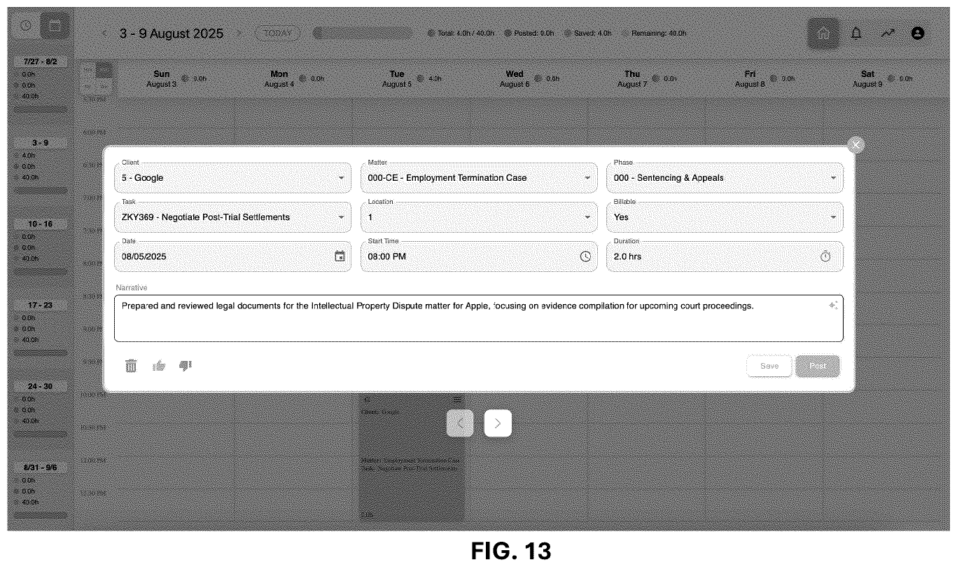

FIGS. 12 and 13 specifically illustrate the entries shown in FIGS. 10 and 11.

The systems and methods described herein are advantageous for training a neural network and creating accurate time entries. The disclosed systems and methods are particularly advantageous in reducing processing resources and memory storage through the training and generation of time entries. It should be understood that various changes and modifications to the methods described herein will be apparent to those skilled in the art and can be made without diminishing the intended advantages.

### General Interpretation of Terms

In understanding the scope of the present invention, the term “comprising” and its derivatives, as used herein, are intended to be open ended terms that specify the presence of the stated features, elements, components, groups, and/or steps, but do not exclude the presence of other unstated features, elements, components, groups, integers and/or steps. The foregoing also applies to words having similar meanings such as the terms, “including”, “having” and their derivatives. Also, the terms “part,” “section,” or “element” when used in the singular can have the dual meaning of a single part or a plurality of parts. Accordingly, these terms, as utilized to describe the present invention should be interpreted relative to a connecting device.

The term “configured” as used herein to describe a component, section or part of a device includes hardware and/or software that is constructed and/or programmed to carry out the desired function.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such features. Thus, the foregoing descriptions of the embodiments according to the present invention are provided for illustration only, and not for the purpose of limiting the invention as defined by the appended claims and their equivalents.

What is claimed is:

1. A computer-implemented method of training a neural network to create time entries, the method comprising:
retrieving user data related to a task performed by a user;
creating a first training set comprising the user data as an input and an approved time entry as an output;
training the neural network in a first stage using the first training set;
creating a second training set comprising the user data as an input and a revised time entry as an output; and
training the neural network in a second stage using the second training set.

2. The method of claim 1, wherein
the user data relates to an event on the user's digital calendar.

3. The method of claim 1, wherein
the user data relates to a document saved via a word processing application.

4. The method of claim 1, wherein
the user data relates to an email to or from the user.

5. The method of claim 1, wherein
the approved time entry includes a time entry generated by the neural network and approved by the user.

6. The method of claim 1, wherein
the user data relates to operating system data.

7. A system programmed to generate time entries using the neural network trained by the method of claim 1.

8. A system for generating time entries, the system comprising:
a user terminal configured to enable a user to record an amount of time elapsed between a start time and an end time on a particular date;
a central server including a controller having a processor and a memory, the memory storing a neural network configured to generate the time entries, the controller causing the processor to execute instructions stored on the memory to (i) retrieve user data related to a task performed by the user between the start time and the end time on the particular date, (ii) retrain the neural network using the user data as an input and one or more approved time entry as an output, and (iii) generate new time entries using the retrained neural network.

9. The system of claim 8, wherein
the user data relates to information available through the user terminal.

10. The system of claim 8, wherein
the user terminal is a smart watch, and
the user wearing the smart watch causes the smart watch to record the amount of time elapsed between the start time and the end time on the particular date by starting and stopping a running timer on the smart watch.

11. The system of claim 8, wherein
the user terminal includes a running timer configured to be started and stopped by a user to cause the user terminal to record the amount of time elapsed between the start time and the end time on the particular date.

12. The system of claim 8, wherein
the approved time entry includes a time entry generated by the neural network and approved by the user.

13. The system of claim 8, wherein
the revised time entry includes a time entry generated by the neural network and rejected by the user.

14. The system of claim 8, wherein
the user data relates to at least one of an event on a digital calendar, a document saved via a word processing application, or an email to or from the user.

15. A method of generating time entries, the method comprising:
recording, by a user at a user terminal, an amount of time elapsed between a start time and an end time on a particular date;
retrieving user data related to the user which falls between the start time and the end time on the particular date;
automatically generating an initial time entry having the elapsed time as a duration and a narrative generated by a neural network;
presenting, via the user terminal, the generated time entry to the user who recorded the amount of time elapsed; and
retraining the neural network based on the user approving or disapproving the generated time entry.

16. The method of claim 15, comprising
storing the user data in a data module, and
retraining the neural network using the user data stored in the data module as an input and the generated time entry as the output.

17. The method of claim 15, comprising
storing the user data in a data module, and
retraining the neural network using the user data stored in the data module as an input and a revised version of the generated time entry as the output.

18. The method of claim 15, comprising
storing the user data in a data module,
creating a positive training set comprising the user data as a training input and data from a revised time entry as a training output,
retraining the neural network in one stage using the positive training set,
creating a negative training set comprising the user data as the training input and data from the initial time entry as the training output, and
retraining the neural network in another stage using the negative training set.

19. The method of claim 15, wherein
storing a first portion of the user data in a data module, and
purging a second portion of the user data prior to retraining the neural network.

20. The method of claim 15, wherein
the user data relates to at least one of an event on a digital calendar, a document saved via a word processing application, or an email to or from the user.
